(19) United States
(12) Patent Application Publication
(10) Pub. No.: US 2007/0241599 A1
(43) Pub. Date: Oct. 18, 2007

(54) Chair flexpad support arrangement

(76) Inventor: Dewey Hodgdon, Manchester, MA (US)

Correspondence Address: Donald M. Halgren, 35 Central Street, Manchester, MA, 01944, US

(21) Appl. No.: 11/405,276

(22) Filed: Apr. 17, 2006

(51) Int. Cl. B60N 2/02

(52) U.S. Cl. 297/313

(57) ABSTRACT

A chair support arrangement for permitting tilting of a chair seat and chair back assembly by a sitter thereon. The assembly comprises a chair base having a chair support arm extending therefrom, and a flexpad support arrangement secured to the chair support arm. The flexpad support arrangement comprises a compressible pad having compressible contoured portions to facilitate yielding of the flexpad and tilting of the chair seat and chair back assembly. The compressible contoured portions comprise a front edge and a rear edge of said flexpad. The contours may be comprised of an array of furrows parallel to one another and to the upper and lower surfaces of the pad.

### BACKGROUND OF THE INVENTION

1. Field of the Invention

The present invention relates to supports for chairs, and more particularly to flexible support arrangements for supporting a tiltable chair seat and seat back.

2. Prior Art

Providing a comfortable seat for a wide variety of seat occupants is always a challenge. Such a capability must be present in public seating arrangements, for example such as those found in the health care market. Such a seat must be comfortable and somewhat maneuverable for a wide range of people, be they heavy or light, wide or narrow. Such seat accommodations should also be non-adjustable in their tilting capacities. The chair and furniture industry have yet to provide such a simple, widely utilizable chair arrangement in an inexpensive format, particularly to service the healthcare market. My earlier patents U.S. Pat. Nos. 4,871,208 and 5,649,740 are cited herein as prior art, and are also incorporated herein by reference.

It is an object of the present invention, to overcome the disadvantages of the prior art chair support assemblies.

It is a further object of the present invention to provide a chair support arrangement which will be passive yet very accommodating in its capability to provide comfortable yet tiltable accommodative support front and back as well as side to side, thus a 360 degree range of tiltable motion, for a wide variety of users.

It is still yet a further object of the present invention, to provide a chair support arrangement which has a wide range of embodiments which may be selected by the manufacturer thereof.

### BRIEF SUMMARY OF THE INVENTION

The present invention relates to a chair assembly, preferably comprising a molded chair seat back unitarily molded with a chair seat. That seating surface is supported on a wheeled base, by a height-adjustable column having an upper end with a chair support arm arranged thereon. The chair support arm has a distal end which supports a flexpad support arrangement thereon. The flexpad support arrangement is secured between the distal end of the chair support arm and the lower side of the molded chair seat.

The flexpad support arrangement comprises a bottom mounting plate mounted securely to the distal end of the chair's support arm. The bottom mounting plate is preferably of rectangular configuration. A bolt-receiving lower housing is attached to the lower side of the bottom mounting plate.

A flexpad comprised of compressible, resilient material is disposed on the top side of the bottom mounting plate. The flexpad is sandwiched between the bottom mounting plate and an upper mounting plate. The upper mounting plate is attached to the molded chair seat portion by an arrangement of seat securement bolts. An elongated flexible support arrangement securement bolt is disposed through the upper mounting plate, then through a bore located just forward of the geometric center of the flexpad, and through an opening in the bottom plate and through the bolt-receiving lower housing and locked therein by a bolt lock washer slid into a groove on the lowermost end of the flexible support arrangement securement bolt. The bolt lock washer is secured to the bottom side of the bolt-receiving lower housing by for example, a washer lock pin.

The compressible flexpad itself, in a first preferred embodiment thereof, comprises a multi-sided block of compressible material having a rear edge, a front edge, which is shorter width-wise than the rear edge. The rear edge has angled corners leading to a side edge, the side edges having angled portions which lead to the narrower front edge of the flexpad.

In a first preferred embodiment of the flexpad arrangement, the rear edge of the flexpad has a plurality of furrows arranged transversely thereacross, parallel with the upper and lower surfaces of the flexpad. The front edge of the flexpad has a plurality of furrows or channels disposed horizontally thereacross. Those furrows run parallel with respect to and between the upper and lower surfaces of the flexpad. In the preferred embodiment of the flexpad arrangement, the number of furrows across the front edge of the flexpad is greater than the number of furrows disposed across the rear edge of the flexpad. These furrows extending across the read edge of the flexpad extend into the corner portions of the rear side, those furrows tapering until they have a depth of zero before reaching the side edge of the flexpad.

The furrows in the front edge of the flexpad extend into the corner portions of the front edge and taper to a depth of zero at the corner portions thereof. It is intended that the side edges of the flexpad have no furrows, channels or indentations thereon. The front and rear wall portions of the flexpad comprise the “stretched” and “squeezed” portions of the flexpad, the side wall portions having little or no stretch or compression thereat inasmuch as side tilting is somewhat minimal compared to the front and rear tilting.

In a further embodiment of the present invention, it is intended that the furrows on the rear edge have a sharpened cut thereto, having edges when viewed in a cross sectional viewing thereof. It is also intended at the furrows on the front edge of the flexpad have a cross-sectional representation with sharp edges or corners thereon. Those furrows being in greater number than those formed in the rear edge thereof.

An arrangement of pad bores or material removing voids may be disposed across the rear section of the flexpad extending preferably through the top and bottom surfaces thereof. These pad bores permit a certain inwardly directed flexing in inward bulging, when the flexpad is compressed, to minimize the outward bulging of the sides or end portions of the flexpad. The bore hole for the securement bolt is arranged in a geometically forward location from the center of the center of the flexpad. The bore hole for the securement bolt may be shaped to accommodate the tapered head of the bolt, therein.

In a further preferred embodiment of the present invention, the flexpad may be of somewhat a “D” shape, having curved front side portions and a rather short front edge, and an elongated rear edge with curved rear side portions thereon. In yet a further embodiment of the furrows arranged therein, such adjacently arranged parallel furrows may in a transverse sectional appearance look like a curved sinusoidal pattern or curved surface with one or two or three or more furrows defining the front edge of those waves on the flexpad. A front edge of those furrows in that particular embodiment, may also be sinusoidally curved with a shorter wave height/depth to that curve and with more curves between the lower and the upper edge of the flexpad. Such furrows or sinusoidal curves would extend into the corner portions of the respective front and rear edges. Such sinusoidal furrows would preferably be tapered to a zero depth as it approached the respective side edges. Those side edges would preferably be smooth.

It is intended that the non-adjustable flexpad accommodate a wide range of weights and sizes, and permitting the seat back and seat chair (a shell) to tilt forwardly a slight amount and rearwardly a greater amount by compressing their respective front or rear edges along those particular furrows disposed therein, as well as limited side to side tilting. The flexpad may also be pre-compressed at assembly of the flexpad support arrangements between the upper and lower mounting plates in a further embodiment thereof.

Thus there has been shown a flexpad support arrangement with a uniquely designed flex pad between and upper and lower mounting plate, that flexpad having a unique combination of furrows or indentations along its rearward side and its frontward side and in one preferred embodiment having somewhat hard corners or side edges. The furrows being of different numbers and depths between the front and rearward sides or accommodation thereof, to seat a wide range of people sitting thereon.

The invention thus comprises a chair support arrangement for permitting limited forward and rearward tilting of a chair seat and chair back assembly by a sitter thereon. The arrangement comprises a chair base having a chair support arm extending therefrom; and a flexpad support arrangement secured to the chair support arm wherein the flexpad support arrangement comprises a compressible pad having compressible contoured portions to facilitate yielding of the flexpad and tilting of the chair seat and chair back assembly. The compressible contoured portions may comprise a front edge and a rear edge of the flexpad. The front edge and the rear edge preferably have a plurality of furrows arranged thereon. The front edge of the flexpad preferably has a greater number of furrows thereon than the rear edge of the flexpad. The furrows preferably comprise channels disposed parallel to an upper surface and a lower surface of the flexpad. The furrows may be channels having sharp or “defined” edges thereon. The furrows may be channels having a sinusoidally shaped cross-section thereto. The compressible pad is preferably sandwiched between an upper support plate and a lower support plate. A securement bolt is arranged through the upper support plate and the lower support plate with the pad sandwiched therebetween. The securement bolt extends through a bolt hole in the pad, wherein the bolt hole is disposed in a location forward of the geometric center of the pad. The pad may be pre-compressed between the upper support plate and the lower support plate. The contoured portions may also include rear corner portions and front corner portions thereon. The corner portions may have furrows extending onto at least a portion thereof. The furrows in the corner portions taper in dimensionally to depth of zero thereat. The pad has a generally linear front edge and a generally linear rear edge. The pad may be of a generally “D” shape in a plan view. The pad may have side wall portions of generally smooth configuration. The pad may have a plurality of pad bores therein to permit the pad to “belly-in” during compression of the pad between the upper and lower support plates.

### BRIEF DESCRIPTION OF THE DRAWINGS

The objects and advantages of the present invention will become more apparent, when viewed in conjunction with the following drawings, in which;

FIG. 1 is a side elevational view of a chair assembly constructed according to the principles of the present invention;

FIG. 2 is a perspective exploded view of the flexpad support arrangement of a chair constructed according to FIG. 1;

FIG. 3 is a plan view of a flexpad of the present invention;

FIG. 4 is a view taken along the lines 4-4 of FIG. 3;

FIG. 5 is a plan view of a further embodiment of the flexpad with rounder, softer curved edges thereon; and

FIG. 6 is a sectional view taken along the lines 6-6 of FIG. 5.

### DETAILED DESCRIPTION OF THE PREFERRED EMBODIMENTS

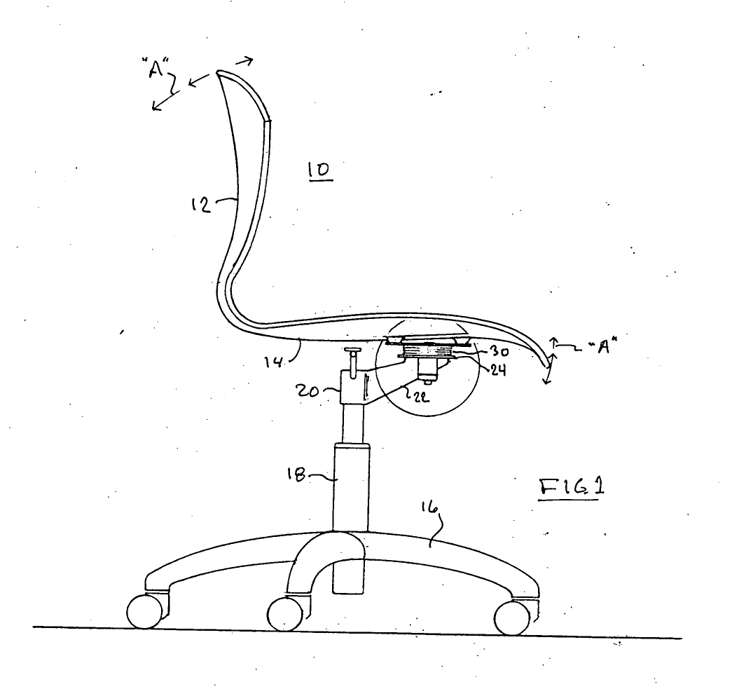

Referring now to the drawings in detail, and particularly to FIG. 1, there is shown the present invention which includes a chair assembly 10, preferably comprising a molded chair seat back 12 unitarily molded with a chair seat surface 14. That seating surface 14 is supported on a wheeled base 16, by a height-adjustable column 18 having an upper end hub 20 with a chair support arm 22 arranged thereon. The chair support arm 22 has a distal end which supports a flexpad support arrangement 24 thereon. The flexpad support arrangement 24 is secured between the distal end of the chair support arm 22 and the lower side of the molded chair seat 14.

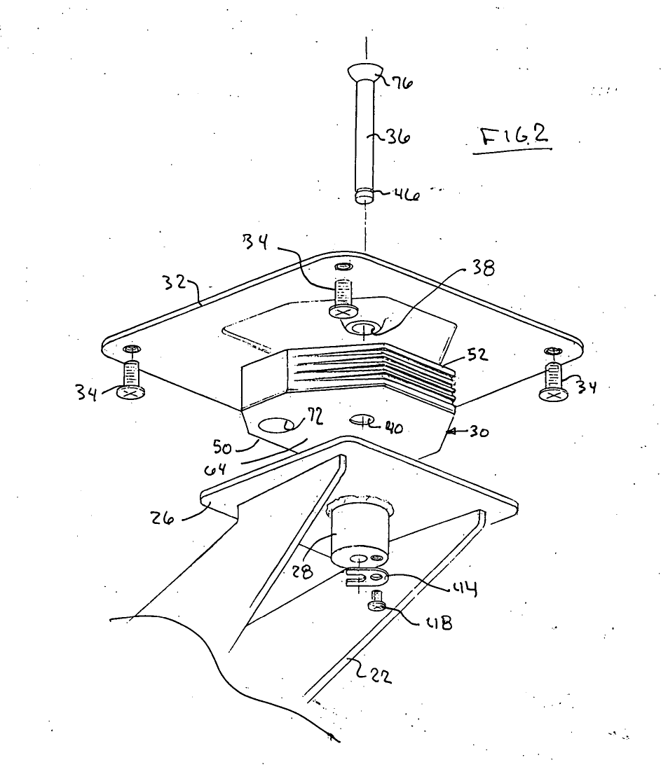

The flexpad support arrangement 24, shown more clearly in an exploded view in FIG. 2, comprises a bottom mounting plate 26 mounted securely by welding or the like, to the distal end of the chair's support arm 22. The bottom mounting plate 26 is preferably of rectangular configuration. A bolt-receiving lower housing 28 is attached to the lower side of the bottom mounting plate 26.

A flexpad 30 comprised of compressible resilient material such as for example, rubber or neoprene, is disposed on the top side of the bottom mounting plate 26. The flexpad 30 is sandwiched between the bottom mounting plate 26 and an upper mounting plate 32. The upper mounting plate 32 is attached to the molded chair seat portion 14 by an arrangement of seat securement bolts 34. An elongated flexible support arrangement securement bolt 36 is disposed through an opening 38 in the upper mounting plate 32, then through a bore 40 located just forward of the geometric center of the flexpad 30, and through an opening 42 in the bottom plate 26, and through the bolt-receiving lower housing 28 and locked therein by a bolt lock washer 44 slid into a groove 46 on the lowermost end of the flexible support arrangement securement bolt 36, as represented in FIG. 2. The bolt lock washer 44 is secured to the bottom side of the bolt-receiving lower housing 28 by a washer lock pin 48.

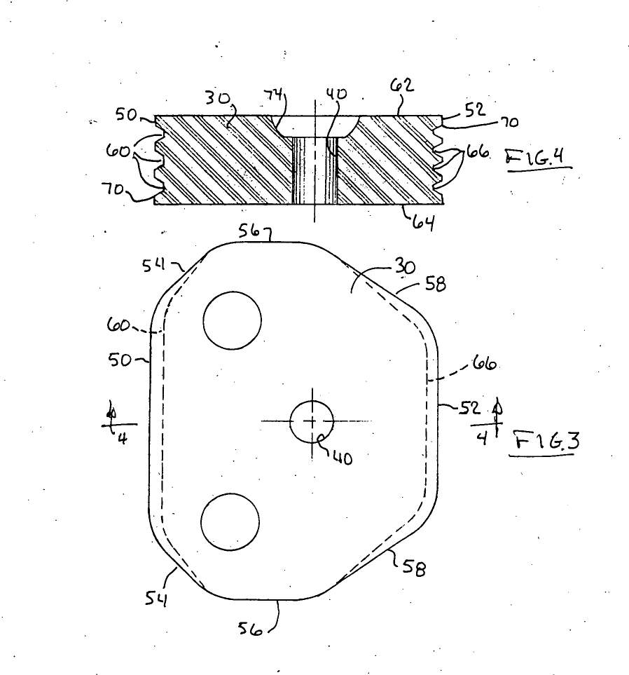

The compressible flexpad 30, in a first preferred embodiment thereof as represented in FIGS. 3 and 4, comprises a multi-sided block of compressible material having a linear rear edge 50, a linear front edge 52, which is shorter width-wise than the rear edge 50. The rear edge 50 has generally linear angled corner portions 54 leading to a linear side edge 56. The side edges 50 and 52 having generally linear front angled portions 58 which lead to and blend in with the narrower front edge 52 of the flexpad 30.

In a first preferred embodiment of the flexpad 30, as represented in FIGS. 3 and 4, the rear edge 50 of the flexpad 30 has a plurality of furrows 60 arranged transversely thereacross, parallel with the upper and lower surfaces 62 and 64 of the flexpad 30. The front edge 52 of the flexpad 30 has a plurality of furrows 66 or channels disposed horizontally thereacross, as represented in FIGS. 3 and 4. Those front furrows 66 run parallel with respect to and between the upper and lower surfaces 62 and 64 of the flexpad 30. In one preferred embodiment, the furrows may be also curved along their longitudinal direction (not shown for clarity). In another preferred embodiment of the flexpad 30, the number of furrows 66 across the front edge 52 of the flexpad 30 is greater than the number of furrows 60 disposed across the rear edge 50 of the flexpad 30. These furrows 60 extending across the rear edge 50 of the flexpad 30 extend into the corner portions 54 of the rear side, those furrows 60 tapering down until they have a depth of zero before reaching the side edges 56 of the flexpad 30, as represented in FIG. 1 and FIG. 3.

The furrows 66 in the front edge 52 of the flexpad 30 extend into the corner portions 58 of the front edge 52 and taper to a depth of zero at the corner portions thereof, as represented in FIGS. 1 and 3. It the preferred that the side edges 56 of the flexpad 30 have no furrows, channels or indentations thereon. The side to side tilting therefore, will be not as extensive as the front to rear tiltability of the chair assembly 10.

In a further embodiment of the present invention, as represented in FIGS. 3 and 4, it is intended that the furrows 60 on the rear edge 50, have a sharpened cut thereto, having edges 70 when viewed in a cross sectional viewing thereof, shown in FIG. 4. It is also intended at the furrows 66 on the front edge 52 of the flexpad 30 may also have a cross sectional representation with the “hard” or somewhat sharp edges or corners 70 thereon, as again represented by FIG. 4. Those furrows 66 on the front side 52 preferably being in greater number than those formed in the rear edge 50 thereof to give greater tiltability in one direction (forward) than over the other direction.

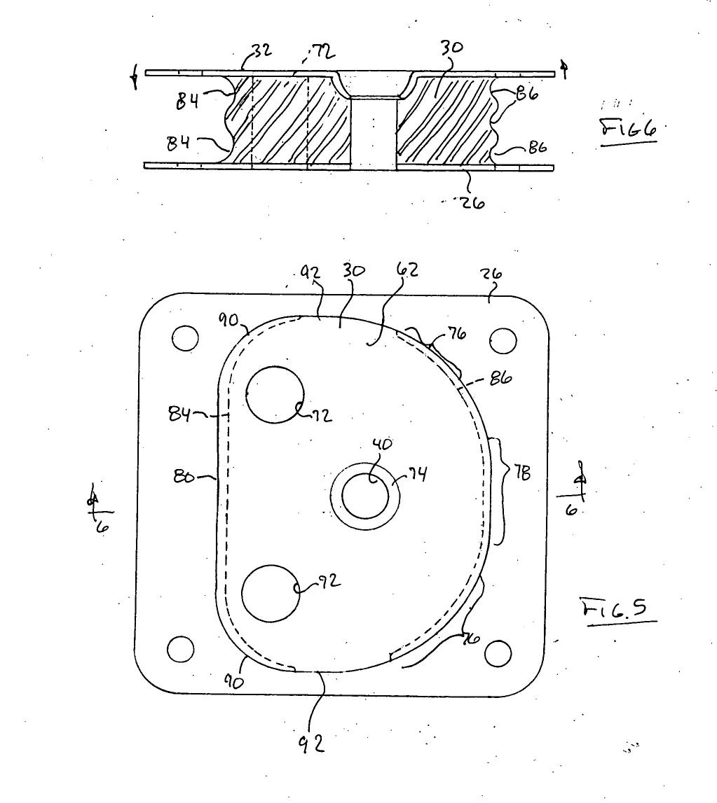

An arrangement of pad bores or material removing voids 72 may be disposed across the rear section of the flexpad 30 extending preferably through the top and bottom surfaces 62 and 64 thereof. These pad bores 72, shown in FIGS. 1, 3 and 5, permit a certain inwardly directed flexing and inward bulging, when the flexpad 30 is compressed by a sitter on the chair assembly 10, to minimize the otherwise outward bulging of the sides 56 or end portions 50 and 52 of the flexpad 30. The bore hole 40 for the securement bolt 36 is arranged in a geometrically forward location from the center of the center of the flexpad 30, as represented in FIGS. 3, 4, 5 and 6. The bore hole 40 for the securement bolt 36 may have an “indented” or curved shape 74, as represented in FIGS. 3 and 5, so as to accommodate the tapered head 76 of the bolt 36, therein.

In a further preferred embodiment of the present invention as represented in FIGS. 5 and 6, the flexpad 30 may be of somewhat a “D” shape, having curved front side portions 76 and a rather short linear front edge 78, and an elongated generally linear rear edge 80 with curved rear side portions 82 thereon, best represented in FIG. 5. In yet a further embodiment of furrows arranged in the flexpad 30, such adjacently arranged rear parallel furrows 84 may in a transverse sectional appearance look like a curved sinusoidal pattern or curved surface and with one or two or three or more furrows 86 defining the front edge 78 of those waves on the flexpad 30. A front edge of those furrows in that particular embodiment, may also be sinusoidally curved with a shorter wave height/depth to that curve and with more curves between the lower and the upper surfaces 62 and 64 of the flexpad 30. Such furrows or sinusoidal curves 86 and 84 would extend into the corner portions 76 and 90 of the respective front and rear edges 78 and 80. Such sinusoidal furrows 84 and 86 would preferably be tapered to a zero depth as they approach their respective side edges 92. Those side edges 92 would preferably be smooth.

It is intended that the non-adjustable flexpad 30 is calibrated by its thickness, durometer and profile to comfortably accommodate a wide range of weights and sizes, and permitting the seat back 12 and seat chair portion 14 to tilt forwardly a slight amount and rearwardly a slight amount, as represented by arrow “A” in FIG. 1, by compressing their respective front or rear edges 52 and 50 along those particular furrows 66 and 60 disposed therein, as well as some side to side movement. The flexpad 30 may be pre-compressed at assembly of the flexpad support arrangements between the upper and lower mounting plates 32 and 26 in a further embodiment thereof.

Thus there has been shown a flexpad support arrangement with a uniquely designed flexpad between and upper and lower mounting plate, that flexpad having a unique combination of furrows or indentations along its rearward side and its frontward side and in a preferred embodiment having somewhat hard corners or side edges. The furrows being of different numbers and depths between the front and rearward sides or accommodation thereof, to seat a wide range of people sitting thereon.

I claim:

1. A chair support arrangement for permitting limited forward and rearward tilting of a chair seat and chair back assembly, by a sitter thereon, comprising:
a chair base having a chair support arm extending therefrom; and
a flexpad support arrangement secured to said chair support arm wherein said flexpad support arrangement comprises a compressible pad having compressible contoured portions to facilitate yielding of said flexpad and tilting of said chair seat and chair back assembly.

2. The chair support arrangement as recited in claim 1, wherein said compressible contoured portions comprise a front edge and a rear edge of said flexpad.

3. The chair support arrangement as recited in claim 2, wherein said front edge and said rear edge have a plurality of furrows arranged thereon.

4. The chair support arrangement as recited in claim 3, wherein said front edge of said flexpad has a greater number of furrows thereon than said rear edge of said flexpad.

5. The chair support arrangement as recited in claim 3, wherein said furrows comprise channels disposed parallel to an upper surface and a lower surface of said flexpad.

6. The chair support arrangement as recited in claim 3, wherein said furrows are channels having sharp edges thereon.

7. The chair support arrangement as recited in claim 3, wherein said furrows are channels having a sinusoidally shaped cross-section thereto.

8. The chair support arrangement as recited 1, wherein said compressible pad is sandwiched between an upper support plate and a lower support plate.

9. The chair support arrangement as recited in claim 8, wherein a securement bolt is arranged through said upper support plate and said lower support plate with said pad sandwiched therebetween.

10. The chair support arrangement as recited in claim 9, wherein said securement bolt extends through a bolt hole in said pad, wherein said bolt hole is disposed in a location forward of the geometric center of said pad.

11. The chair support arrangement as recited in claim 9, wherein said pad is pre-compressed between said upper support plate and said lower support plate.

12. The chair support arrangement as recited in claim 2, wherein said contoured portions also includes rear corner portions and front corner portions thereon.

13. The chair support arrangement as recited in claim 12, wherein said corner portions have furrows extending onto at least a portion thereof.

14. The chair support arrangement as recited in claim 13, wherein said furrows in said corner portions taper in dimensionally to depth of zero thereat.

15. The chair support arrangement as recited in claim 1, wherein said pad has a generally linear front edge and a generally linear rear edge.

16. The chair support arrangement as recited in claim 1, wherein said pad is of a generally “D” shape in a plan view.

17. The chair support arrangement as recited in claim 2, wherein said pad has side wall portions of generally smooth configuration.

18. The chair support arrangement as recited in claim 8, wherein said pad has a plurality of pad bores therein to permit said pad to belly-in during compression of said pad between said upper and lower support plates.
